(19) United States
(12) Patent Application Publication
(10) Pub. No.: US 2018/0288583 A1
(43) Pub. Date: Oct. 4, 2018

(54) IN-HOUSE FIXTURE OR SIGNAGE WITH LOCATION BASED INTELLIGENCE

(71) Applicant: McRae Imaging, Mississauga (CA)

(72) Inventors: Hani Abdelgallil, Uxbridge (CA); Robert M. Murray, Oakville (CA); Ryszard W. Kisiel, Mississauga (CA)

(21) Appl. No.: 15/937,925

(22) Filed: Mar. 28, 2018

Related U.S. Application Data
(60) Provisional application No. 62/477,785, filed on Mar. 28, 2017.

(51) Int. Cl. H04W 4/23; H04W 4/02; H04W 4/80

(52) U.S. Cl. CPC H04W 4/23; H04W 76/10; H04W 4/80; H04W 4/02

(57) ABSTRACT

A display fixture that is enabled with location tracking systems to locate customers in a retail or trade environment and provide a more holistic experience for the customer that works through, rather than in competition, with the customer's mobile device. An App on a customer's mobile device enables location tracking systems on the mobile device such as GPS, WiFI tracking, Bluetooth Low Energy (BLE), in order to locate the customer within a retail or trade environment while the App is operational. Display fixtures are equipped with beacon devices to aid in the identification of the location of the customer mobile device relative to the display fixture. Proximity of the customer device may cause the App to deliver an experience to the customer via the mobile device and/or trigger a response in the display fixture itself.

### RELATED APPLICATIONS

This non-provisional application claims the benefit of U.S. Provisional Application 62/477,785 filed on Mar. 28, 2017, which is incorporated herein by reference in its entirety.

### FIELD OF THE INVENTION

The present invention relates to fixtures of the type used for promotional presentations at businesses and trade displays, and provision of location based services at those locations and events.

### BACKGROUND OF THE INVENTION

In-store fixtures, signs and displays, including lightboxes, neon signs, and the like, (all of which will hereafter be identified as “display fixtures”) have been used for many years to attract attention to a business or to a display at a trade show or other commercial venue. These display fixtures typically include bright colors, carefully designed corporate logos and photography, and include bright backlighting, all for the purpose of capturing the attention of passing prospective customers.

The use of display fixtures has reached a level of maturity and sophistication that is effective for the purpose of gathering attention, but recently has been confronted with a new form of competition, namely, the increasing amount of attention that is drawn to personal mobile devices being carried by individuals as they travel through the world. Often prospective customers are so consumed with content on a smart phone, tablet, or other mobile device that the efficiency of a well-designed and well-lit display fixture can be completely eviscerated.

Electronics have long been used to monitor locations and provide personal safety, as well as to detect and permit movements such as with the opening and closing of doors. Electronic systems could even cause interactive responses by a display based on the nearness of a person. However, the advent of personal mobile devices threatens to undermine the value of display fixtures.

Most modern mobile devices, such as personal digital assistants, cellular phones, smart phones, tablet computers, and the like, include application programming interfaces (APIs) and circuitry that can monitor the movement and position of the device when enabled by applications (Apps) running on the API; using this approach, applications have been developed for devices to monitor surrounding areas, often with the use of connected peripheral equipment such as sensors and cameras.

There have been studies and proposals suggesting that mobile phone transmissions could be tracked in various ways. For example, the white paper published by the Electronic Frontier Foundation at https://ssd.eff.org/en/module/problem-mobile-phones, entitled “The Problem with Mobile Phones” notes that mobile phones deliver a number of transmissions which can be monitored and which have the effect of compromising personal privacy and security. The paper notes a number of privacy compromises, the first of which is the possibility of tracking the location of the user via cell phone towers, IMSI catchers or even Wi-Fi or Bluetooth radios. An example of an IMSI-IMEI-TMSI catcher is currently available for sale from Ability Computers & Software Industries Ltd. Of 14 Yad Harutzim Street, Tel Aviv Israel. Methods for capturing data by such devices are described, for example, in PCT Publication WO 2007010223 A1, which is hereby incorporated by reference herein in its entirety.

While the capture of IMSI-NEI-TMSI codes (which will be generally referenced herein as IMSI codes) from mobile telephones is a security and privacy concern, in some cases the trackability of a phone can prove useful, as elaborated by U.S. Patent Publication 2012/0064855 which describes a monitoring device usable by first responders to search for trapped people in an emergency area by monitoring for mobile telephone transmissions. Furthermore, there have been proposals that the ongoing transmissions made by mobile devices could aid in developing social connections; for example, U.S. Pat. No. 8,355,473 describes a communication device that determines whether there is a social interaction between a user of the device and a user of a second device, and if so, the communication device stores identification information of the second device to track that social interaction. Each of these prior publications is incorporated herein by reference in its entirety.

Devices have been developed and are presently being marketed that enable location based services for mobile devices. For example, Estimote, Inc. of 35 E 19^{th} Street, 2^{nd} Floor, New York, N.Y. 10003, sells a line of devices described as “tiny, low power computers” that may be attached to walls or objects in the physical world, and use proximity technologies such as Bluetooth Low Energy to detect human presence and behavior and trigger pre-programmed actions, that create “contextual and personalized experiences” for the person.

### SUMMARY OF THE INVENTION

The present invention provides a signage system including a display fixture that is enabled with location based intelligence to locate customers in a retail or trade environment and provide a more holistic experience for the customers that works through, rather than in competition, with the customer's mobile device.

In a detailed embodiment, an App is developed for installation on the API of the customer's mobile device, which enables location tracking systems on the mobile device such as GPS, WiFI tracking, Bluetooth Low Energy (BLE) or other location tracking available through the API, in order to locate the customer within a retail or trade environment while the App is operational. Display fixtures are equipped with beacon devices such as those available from Estimote to aid in the identification of the location of the customer mobile device relative to the display fixture.

When the App detects the proximity of the customer to a location for which a behavior has been programmed, the App may then deliver an experience to the customer via the mobile device and/or trigger a response in the display fixture itself.

The Information provided to the customer in the triggered experience may vary depending upon the distance between the display fixture and customer/mobile device. For example, the mobile device may merely advertise the enhanced experience when distant from the display fixture, and commence the enhanced experience when the customer/mobile device approaches the display fixture. The experience may be wholly presented on the mobile device or may be presented on the display fixture (e.g., via a synchronized or asynchronous video presentation, light intensity, color hue or color temperature change at the display fixture, all of which may be carefully designed to capture the customer's attention and draw the customer in for even more immersive experiences.

The invention contemplates the deployment of multiple display fixtures and/or multiple beacon devices to provide a richer interactive experience based upon the position and movements of the customer and his/her mobile device, such as by the synchronization of display fixture presentations of video with the movement or desired movement of the customer, or synchronized light intensity, color hue or color temperature changes to guide a customer through an experience or potentially goad further interactions.

In a particular embodiment the invention is implemented using a battery powered standalone beacon device such as is sold by Estimote, Inc., but may also be implemented by integrating the beaconing device into the display fixture power circuits (typically LED lighting) so as to eliminate the need for battery power.

The above and other objects and advantages of the present invention shall be made apparent from the accompanying drawings and the description thereof.

### BRIEF DESCRIPTION OF THE DRAWINGS

FIG. 1 is a diagram illustrating the movements of persons bearing mobile devices through various geographic locations;

FIG. 2 is a block diagram illustrating the internal operating parts of a device using principles of the present invention, including a processor and peripheral systems within the device or working in conjunction with the device and a display fixture to implement principles of the present invention;

FIG. 3 is a process diagram illustrating an exemplary monitoring process implemented by the device of FIG. 2, to control the display fixture and create experiences for customers interacting with the beacons;

The accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION OF THE INVENTION

Various non-limiting embodiments of the present disclosure will now be described to provide an overall understanding of the principles of the structure, function, and use of the mobile device monitoring systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The presently disclosed embodiments are generally directed to wireless communications between beacons and mobile devices, and the configuration of mobile devices or stationary devices to provide a response that is unique to each device. The devices themselves are identified by unique identifying information, e.g. identifying codes, that are exchanged wirelessly.

In various embodiments, the mobile device may detect the transmissions through generally passive detection processes. In other words, a customer does not necessarily have to routinely initiate or activate the detection process. Instead, the detection process may be a background routine that operates in the random access memory (RAM) of a mobile device, as a background process under control of the mobile device API, for example. The background routine may periodically, or at least routinely, query signals received or generated by various on-board or connected wireless components in order to detect if a wireless transmission is present. These queries may be performed without additional input from the consumer. Components queried by the detection process may include, without limitation, on-board Bluetooth, Wi-Fi, NFC or cellular radios, IMEI catching systems, or connected peripherals containing the same.

In some embodiments, the action of the mobile device may be a function of where the device is geographically located. In other words, a mobile device in a trade show or other trade environment, that detects a beacon may initiate a control strategy for an experience, generate a notification to the customer, and/or request additional information, based upon the type of location and relevant context, whereas a device in a residential environment may not perform these functions or may perform different functions. Additionally, the behavior of the monitoring device may depend on other information, such as whether the mobile device has detected the same beacon device previously, and so forth. Consumer preferences and user-supplied data may be part of this determination.

In some embodiments, detections of beacons may be compared to certain parameters or thresholds. The thresholds may relate to a total number of times the beacon has been detected, strength of detected signal, duration of detection, and so forth. These thresholds may determine whether an action is taken by the mobile device. In one embodiment, the mobile device generates control are generated including the content received.

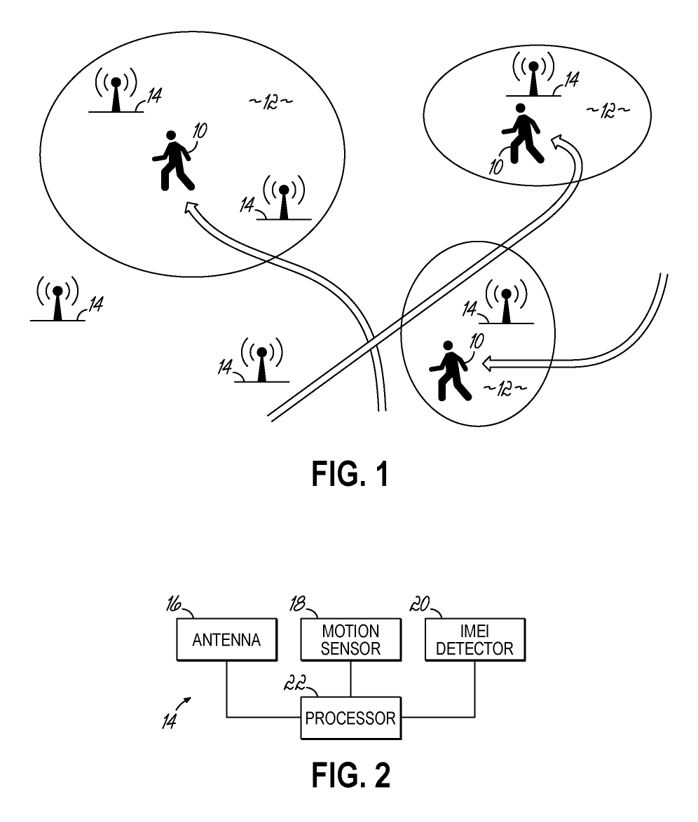

Turning now to the Figures, wherein like numbers indicate like features through the views, FIG. 1 illustrates a variety of exemplary social/spatial environments in which the monitoring systems and processes described herein may be implemented to flag the proximity of persons to beacon enabled fixtures 14 through their mobile device. As shown in FIG. 1, mobile device users, indicated at 10, generally move between a number of different social environments and buildings. These environments may include office buildings, retail stores, trade show floors, and the like, represented by location circles 12, typically having a limited number of potential interactions; more populated environments such as trade show floors have the potential for large numbers of interactions. Notably, interactions may occur in outdoor spaces including parking lots, sidewalks, and recreation areas. Each of these locations is represented as a generally circular range, wherein the beacons are located within the monitored location. Each of these different environments present opportunities for mobile devices to encounter beacons. The process described below monitors for the presence of a beacon in these different types of environments.

In each of the environments depicted in FIG. 1, beacons broadcast unique identification information, such as a MAC address or IMEI, within a proximity zone in three-dimensional space. A range of zones can exist, with the number and types of interactions occurring within a zone depending upon the type of social environment. The distance at which a mobile device can detect a beacon may vary according to signal power and characteristics.

FIG. 2 is a block diagram depiction of an example embodiment of the internal operating parts of a beacon enabled fixture 14 through which the methods and systems described herein may be implemented. Fixture 14 typically includes a module and antenna 16 for transmitting and receiving Bluetooth or other communication such as WiFi, NFC and/or other short range wireless radio communication signals, either for Internet communication for the processor, or for detection of Bluetooth, WiFi, NFC or other wireless transmissions of other mobile devices for the purposes of the present invention.

Fixture 14 may passively emit transmissions for detection by passing mobile devices, or may include active circuits and systems. For example, the fixture 14 may further include a motion sensor 18 that may be placed on a door or other access point to detect moving objects in an area. Upon sensing a person, the motion sensor may transmit a signal to the monitoring device in order to provide a possible alert. An IMEI detector 20 may also be used in conjunction with the monitoring device. IMEI detector 20 detects wireless transmissions of unique IMEI codes from mobile telephones, or mobile devices equipped with a built-in mobile telephone circuitry, and transmits the codes to fixture 14. Within fixture 14, a processor 22 analyzes captured information and determines whether to generate an alert, as elaborated below.

It will be appreciated that the various components of FIG. 2 may be internal operating parts within a housing, or peripheral components connected (either wired or wirelessly) to the housing that includes the processor. For example, the IMEI detector 20 and motion sensor 18 may be peripheral components connected wirelessly to the processor 22, so that they may capture activity of persons in proximity to the fixture 14, and communicate the detection to the fixture 14. In some embodiments, motion sensor 18 and/or IMEI detector 20 may be incorporated into the monitoring device rather than being a peripheral device.

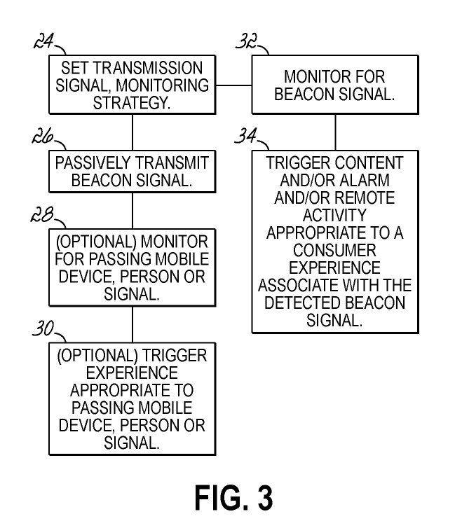

FIG. 3 shows one example of a monitoring process implemented by a beacon-enabled fixture 14. As shown in FIG. 3, beacon-enabled fixture 14 is initialized 24 at the beginning of the process. The initialization typically occurs at first use of the fixture 14, but the process may be reinitialized at a later time in order to change rules and settings. The initialization step can include setting transmitted signal characteristics, alert threshold levels, designating locations, days, or times at which to provide control strategies or to restrict the same, and other rules. After initialization, the process enters a passive transmission mode 26 to look for, and optionally monitor for signals from other mobile devices. These signals include, but are not limited to, Bluetooth, Wi-Fi, NFC transmissions and/or cellular radio signals. Fixture 14 may, optionally monitor 28 for and capture the wireless broadcast signals. The captured signals are evaluated by logic in processor to detect unique identification codes, which can include MAC addresses, from monitored mobile devices. When a mobile device or signal (and MAC address, NEI, etc.) is detected, in one embodiment, the processor may take a variety of actions appropriate to trigger an experience for the passing mobile device or person.

As further shown in FIG. 3, a mobile device running an App on the mobile device API according to the invention also runs a process which monitors 32 for a beacon signal, and when one is detected, retrieves content, triggers an alarm, or triggers remote activity such as by one or more display fixtures to create an appropriately designed consumer experience (step 34).

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A signage system comprising
a. a display fixture,
b. a beacon circuit integrated with the display fixture,
c. a mobile device programmed for location based functions to locate customers in a retail or trade environment near the display fixture; the mobile device programmed to provide a marketing experience for a user customer upon detection of proximity to the beacon circuit.

2. The signage system of claim 1 wherein the mobile device is programmed using an application on the application programming interface of the mobile device, the application enabling location tracking systems on the mobile device and locating the customer while the application is operational.

3. The signage system of claim 2 wherein the location tracking system comprises one or more of the group consisting of: GPS, WiFI tracking, and Bluetooth Low Energy (BLE).

4. The signage system of claim 1 wherein, upon detection of proximity of the mobile device to a beacon circuit, the mobile device determines whether it is at a location for which an experience has been programmed, and delivers said experience to the via a mobile device display and/or speaker.

5. The signage system of claim 1 wherein, upon detection of proximity of the mobile device to a beacon circuit, the mobile device determines whether it is at a location for which an experience has been programmed, and triggers a response by the display fixture via wireless communication with the display fixture.

6. The signage system of claim 1 wherein marketing experience is delivered differently based upon the distance between the display fixture and mobile device.

7. The signage system of claim 6 wherein the mobile device advertises an experience when distant from the display fixture.

8. The signage system of claim 6 wherein the mobile device commences an experience when the mobile device approaches the display fixture.

9. The signage system of claim 1 wherein the experience is presented on the mobile device.

10. The signage system of claim 1 wherein the experience is presented on the display fixture.

11. The signage system of claim 10 wherein the experience comprises one or more of a video presentation, light intensity, color hue or color temperature change.

12. The signage system of claim 1 comprising a plurality of display fixtures under common control to present an experience.

13. The signage system of claim 1 comprising a plurality of beacon devices under common control to present an experience.

14. The signage system of claim 1 wherein the beacon device is a battery powered standalone beacon device.

15. The signage system of claim 1 wherein the beacon device is integrated into a display fixture power circuit to power the beacon device.
